(19) United States
(12) Patent Application Publication
(10) Pub. No.: US 2008/0062403 A1
(43) Pub. Date: Mar. 13, 2008

(54) TRANSMISSION FLUID CONCENTRATION DETECTOR

(76) Inventors: Chun-Chin Tung, Chupei (TW); Yung-Lieh Chien, Chupei (TW)

Correspondence Address: G. LINK CO., LTD., 3550 BELL ROAD, MINOOKA, IL, 60447, US

(21) Appl. No.: 11/853,031

(22) Filed: Sep. 11, 2007

(30) Foreign Application Priority Data
Sep. 12, 2006 (TW) 095133612

(51) Int. Cl. G01N 21/00

(52) U.S. Cl. 356/72

(57) ABSTRACT

A transmission fluid concentration detector for detecting the fluid concentration in a fluid circulating device is provided, comprises a light-sensing device that consists of at least a light sensor for converting an optical signal into an electrical signals wherein the electrical signal is a signal output by the light sensor under illumination corresponding to the intensity of the optical signal; a light source device; a temperature detector; and a computing device comprising a logic operation means to process electrical signals output by the concentration detector and compute corresponding fluid concentration. The light sensor of the light sensing device and the light source device are arranged oppositely at two sides of a partial space of the fluid circulating device such that the light beam emitted by the light source device can be projected on the light sensor of light sensing device through the fluid in the fluid circulating device. The light sensor then outputs an electrical signal corresponding to the fluid concentration to the computing device, which would determine the corresponding fluid concentration based on the electrical signals output by the light sensing device and the temperature detector.

### FIELD OF THE INVENTION

The present invention relates to a transmission fluid concentration detector, particularly a mechanism for determining fluid concentration through change of optical properties and devices thereof.

### BACKGROUND OF THE INVENTION

Conventional fluid measuring devices perform measurement based on the physical characteristics of fluid, such as concentration, density or quantity. General fluid measuring devices are sizable and complex in structure, and hence are more costly. However there is increasingly market demand for small-size and low-cost products. Take the example of fuel cell system, its applications in portable electronic devices are picking up. In a fuel cell system that uses hydrogen-rich fuel (e.g. methanol) and oxygen fuel to undergo electrochemical reaction and output power, it is necessary for users to know when to replenish the fuel when fluid concentration or level becomes low. Thus it is necessary to detect the fluid fuel level and volume in the fuel container. Such detection work is typically achieved through expensive metering sensor, which is rather uneconomical when used extensively in portable electrical products.

The core of conventional fuel cells lies in the use of hydrogen-rich fluid (e.g. methanol) and oxygen fluid to undergo electrochemical reaction. In the applications of such fuel cells, it is necessary for users to know when to replenish the fuel when fluid concentration or level becomes low. Detection of fluid concentration in the fuel container is typically achieved through expensive metering sensor, which is rather uneconomical when used extensively in portable electrical products. In addition, in the electrochemical reaction of a fuel cell system, variations of fuel temperature along with the progression of the electrochemical reaction might result in measurement errors.

In light of the drawbacks of conventional fluid measuring devices, the inventor aims to develop a transmission fluid concentration detector.

### SUMMARY OF THE INVENTION

The primary object of the invention is to provide a transmission fluid concentration detector that can determine fluid concentration by detecting change in the optical properties of fluid in the fluid circulating device caused by change of fluid concentration.

Another object of the invention is to provide a transmission fluid concentration detector that achieves the calibration of fluid concentration detected through the feedback of fluid temperature by a temperature sensing unit installed in a part of the fluid circulating device.

A further object of the invention is to provide a transmission fluid concentration detector that achieves the calibration of fluid concentration detected by installing in addition a standard fluid tank for accommodating a standard fluid.

To achieve the aforesaid objects, the present invention provides a transmission fluid concentration detector for detecting the fluid concentration of a fluid circulating device, comprising a light-sensing device that consists of at least a light sensor for converting optical signal into electrical signal wherein the electrical signal is a signal output by the light sensor under illumination corresponding to the intensity of the optical signal; a light source device; and a computing device comprising a logic operation means to process the electrical signal output by the concentration detector and compute corresponding fluid concentration. The light sensor of the light sensing device and the light source device are arranged oppositely at two sides of a partial space of the fluid circulating device such that the light beam emitted by the light source device can be projected on the light sensor of light sensing device through the fluid in the fluid circulating device. The light sensor then outputs an electrical signal corresponding to the fluid concentration to the computing device, which would determine the corresponding fluid concentration based on the electrical signal.

Furthermore, a temperature sensing unit is disposed in a partial space of the fluid circulating device corresponding to the light sensing device and the light source device to measure the temperature of fluid in the partial space of the fluid circulating device and feedback the temperature information to the computing device to calibrate the electrical signal that would cause deviation of optical properties due to temperature variation.

In addition, a standard fluid tank can replace the temperature sensing unit, where standard fluid in the standard fluid tank can calibrate the deviation of the electrical signal of fed back temperature. The standard fluid is a fluid with known concentration. The standard fluid tank is correspondingly installed in a partial space of the fluid circulating device such that the temperature of the standard fluid therein corresponds to the fluid temperature in the fluid communication space.

The objects, features and effects of the invention are described in detail below with embodiments in reference to the accompanying drawings.

### BRIEF DESCRIPTION OF THE DRAWINGS

FIG. 1 is a diagram showing the relations of the components in the transmission fluid concentration detector according to the invention;

FIG. 2 is a side view of the transmission fluid concentration detector according to the invention and part of the components used in an embodiment;

FIG. 3 is a side view of the transmission fluid concentration detector according to the invention and part of components used in a second embodiment;

FIG. 4 shows the implementation flow chart of the embodiment in FIG. 3;

FIG. 5 shows the relationships of concentration-transmittance-temperature illustrated by reference table or functional graph; and

FIG. 6 is a side view of the transmission fluid concentration detector according to the invention and part of components used in a third embodiment.

### DETAILED DESCRIPTION OF THE INVENTION

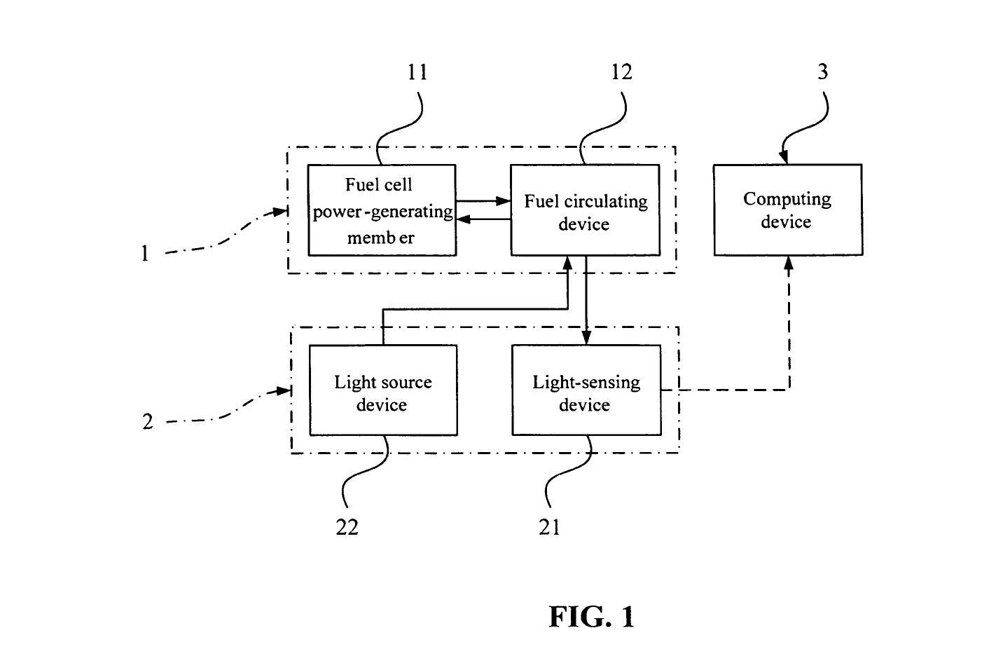

Referring to FIG. 1 which shows the relations of the components in the transmission fluid concentration detector according to the invention, the invention pertains to a concentration detector (2) that can be used in a fuel cell system (1). The concentration detector (2) is correspondingly disposed in a part of the fuel cell system (1) for storing or transporting fluid, detects the concentration of the fluid therein, and outputs a corresponding electrical signal to a computing device (3). The computing device (3) determines the fluid concentration corresponding to the electrical signal.

The fuel cell system (1) comprises a fuel cell power generating member (11) and a fluid circulating device (12). The fuel cell power generating member (11) contains a catalytic substance which catalyzes the electrochemical reaction of hydrogen-rich fluid and oxygen fluid, and an energy converter that converts chemical energy into electrical energy for output. The fluid circulating device (12) is for storing and transporting the fluid needed for the electrical reaction of the fuel cell system (1) and residual solution after the reaction.

The concentration detector (2) comprises a light sensing device (21) and a light source device (22). The light sensing device (21) converts optical signal into electrical signal such that under illumination, the light sensor could output a corresponding current value or another electrical signal based on the dose of light received. The light source device (22) supplies source of light, which is infrared light, visible light or single-wavelength light.

The computing device (3) has logic operation means to process electrical signals output by the concentration detector (2) and computes corresponding fuel concentration. The computing device (3) can be achieved through circuit means and is able to capture the current value output by respective light sensor corresponding to the state of illumination, and based on which output an electrical signal carrying the current value information.

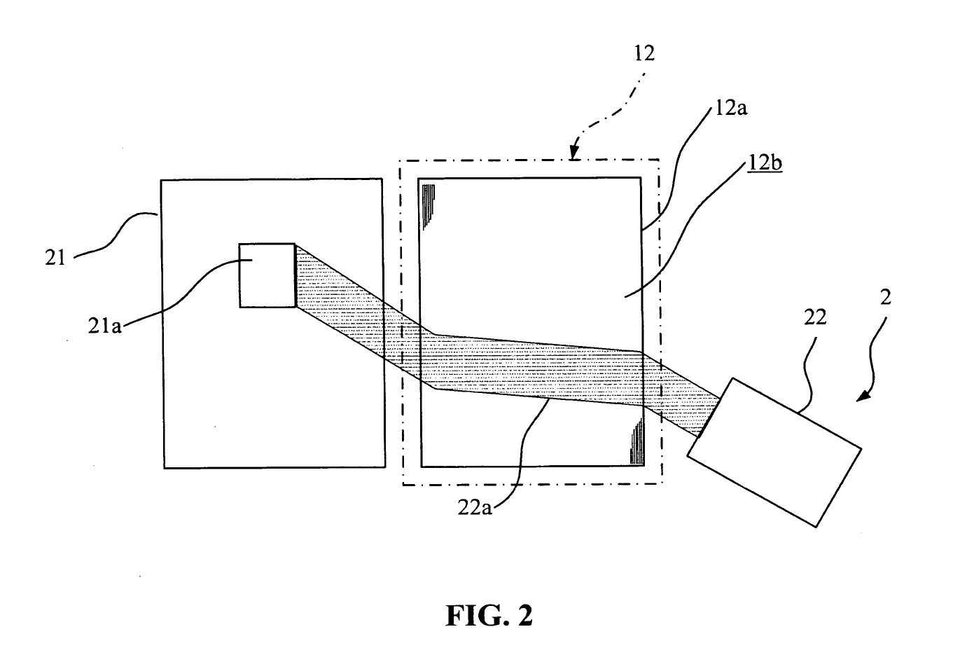

FIG. 2 is a side view of the transmission fluid concentration detector according to the invention and part of the components used in an embodiment. In the aforesaid fuel cell system (1), the fluid circulating device (12) contains a fluid communication space (12a) through which the fluid (12b) in fluid circulating device (12) can be transported or stored. The fluid (12b) stored in fluid circulating device (12) is the mixture of pure water and other compounds. Thus the concentration of the fluid (12b) is determined by the ratio of pure water in the mixture. Moreover, the light sensing device (21) has at least a light sensor (21a) which is a photosensitive element capable of converting optical signal into electrical signal such that under illumination, the light sensor could output a corresponding current value or another electrical signal based on the dose of light received. The light sensing device (21) and the light source device (22) are arranged oppositely at two sides of the part of the fluid communication space (12a) of fluid circulating device (12) such that the light beam (22a) emitted by the light source device (22) can reach the light sensor (21a) of light sensing device (21) through fluid circulating device (12).

Based on the transmission fluid concentration detector of the invention when the light source device (22) in the concentration detector (2) produces a light beam (22a) which is incident on the fluid communication space (12a) of fluid circulating device (12) and penetrates the fluid (12b), part of the light beam (22a) energy is absorbed by the fluid (12b) in the fluid communication space (12a), while the remaining energy is incident on the light sensor (21a) of the light sensing device (21), which would convert the optical signal received into a corresponding electrical signal. Finally the computing device (3) computes based on the electrical signal to obtain the concentration of fluid (12b) in the fluid communication space (12a).

The part of the fluid communication space (12a) in the fluid circulating device (12) corresponding to the light beam (22a) emitted by the light source device (22) and another part of fluid circulating device (12) where the light sensor (21a) receives the light beam (22a) are light transmittable, while the remaining parts of the fluid circulating device (12) are non-light transmittable, hence preventing external light from interfering with the optical signals received by the light sensor (21a). In addition, said part of the fluid communication space (12a) in the fluid circulating device (12) is a space in fluid circulating device (12) for transporting or storing fluid (12b). In fact, the fluid communication space (12a) contains a flow channel for transporting the fluid (12b) or a fluid tank for storing the fluid (12b).

In the first embodiment of the invention, the preferred implementation is the use of a temperature-stable operating system, and the temperature at a specific part of the fluid communication space (12a) where fluid is detected by the concentration detector (2) is known.

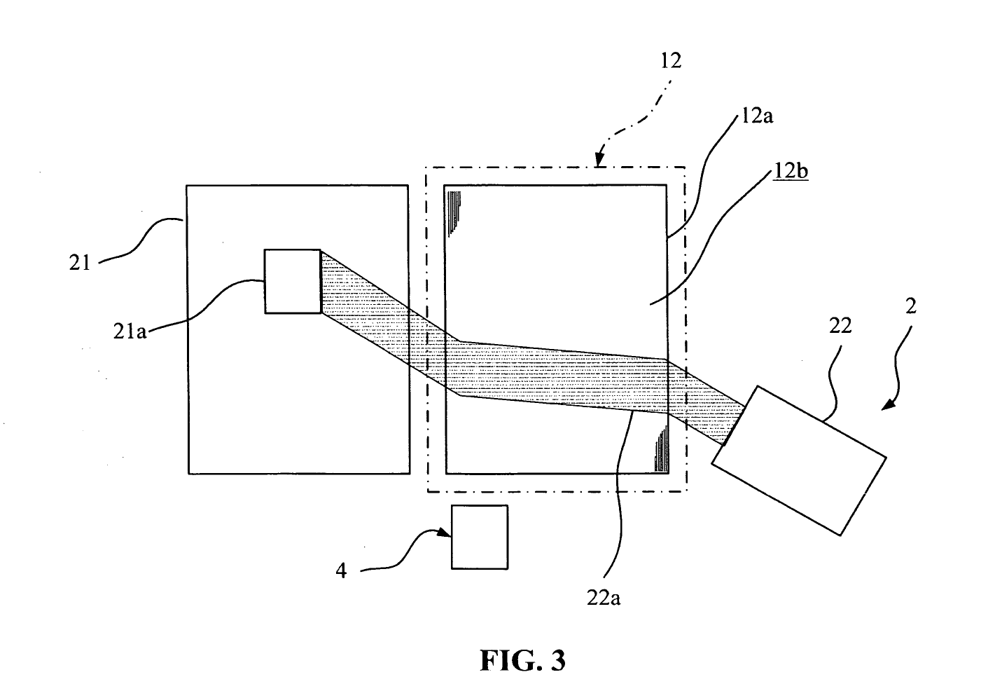

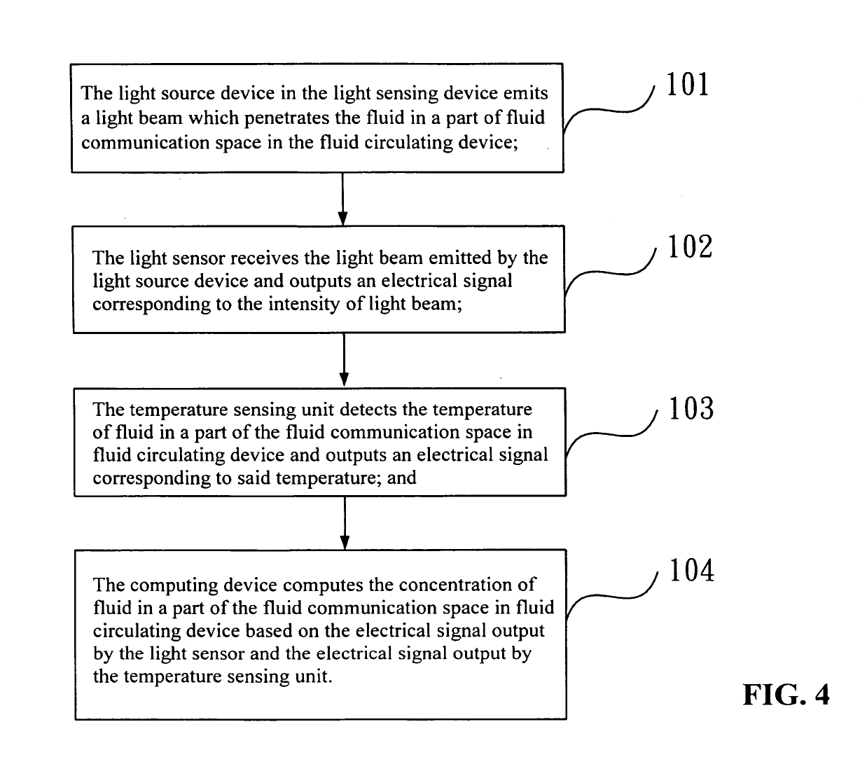

FIG. 3 is a side view of the transmission fluid concentration detector according to the invention and part of components used in a second embodiment; FIG. 4 shows the implementation flow chart of the embodiment in FIG. 3. As shown in FIG. 3, the fuel cell system (1) further comprises a temperature sensing unit (4) correspondingly disposed in a part of the fluid communicating space (12a) in the fluid circulating device (12) such that the temperature sensing unit (4) can measure the temperature of fluid (12b) in the fluid communication space (12a). As shown in FIG. 4, the implementation flow chart of the embodiment in FIG. 3 comprises: step (101) where the light source device (22) of the light sensing device (21) emits a light beam (22a) which penetrates the fluid (12b) in a part of the fluid communication space (12a) in fluid circulating device (12); step (102) where the light sensor (21a) receives the light beam (22a) emitted by the light source device (22) and outputs an electrical signal corresponding to the intensity of light beam (22a); step (103) where the temperature sensing unit (4) detects the temperature of fluid (12b) in a part of the fluid communication space (12a) in fluid circulating device (12) and outputs an electrical signal corresponding to said temperature; and step (104) where the computing device (3) computes the concentration of fluid (12b) in a part of the fluid communication space (12a) in fluid circulating device (12) based on the electrical signal output by the light sensor (21a) and the electrical signal output by the temperature sensing unit (4).

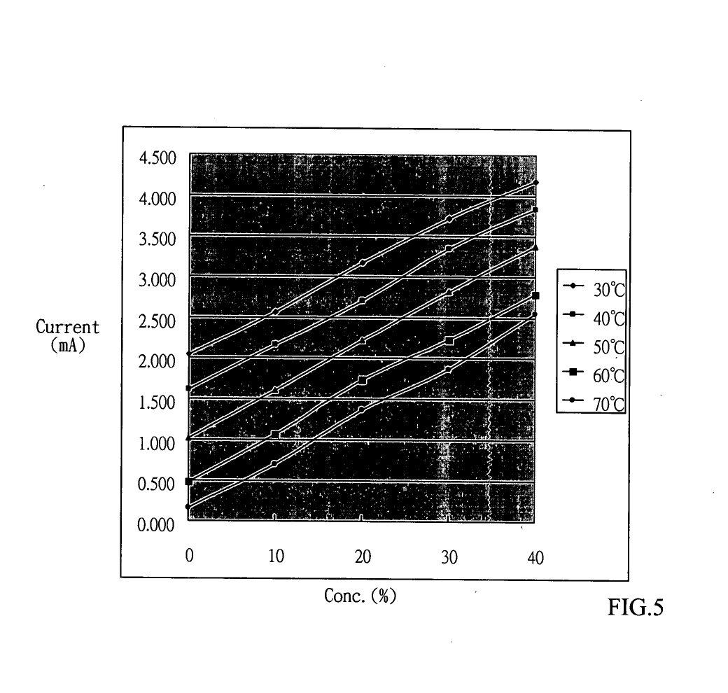

In the aforesaid embodiment, the light beam (22a) produced by the light source device (22) in the concentration detector (2) is preferably steady narrow-band or single-band light source so simplify the factors that would influence the absorption of partial light beam (22a) energy by the fluid (12b) so as to enhance the resolution and the reliability of the light sensing device (21). Moreover, the computing device (3) utilizes a pre-established concentration-transmittance-temperature relationship for determining the concentration of fluid (12b) in a part of the fluid communication space (12a) in fluid circulating device (12) based on the electrical signal output by the light sensor (21a) and the electrical signal output by the temperature sensing unit (4). In the concentration-transmittance-temperature relationship, concentration means the concentration of fluid to be measured; transmittance means the intensity of light from the same light source device (22) that penetrates the fluid to be measured and is received by the light sensing device (21); temperature means the temperature of the fluid to be measured. The concentration-transmittance-temperature relationship can be established through experiments and create a mathematical function for extrapolation. FIG. 5 shows the concentration-transmittance-temperature relationship graph for the transmission fluid concentration detector of the invention. The light beam (22a) produced by the light source device (2) of the concentration detector (2) is narrow-band infrared. When the light beam (22a) is incident on the fluid (12b) in a part of the fluid communication space (12a), part of the light beam (22a) energy is absorbed by the fluid (12b) passing through, whereas the amount absorbed is influenced primarily by the temperature and the concentration of the fluid (12b). Moreover, the intensity of light beam (22a) penetrating the fluid (12b) and illuminating the light sensor (21a) of the light sensing device (21) is viewed as the transmittance of the light beam (22a). The light sensor (21a) receives the part of light beam (22a) that penetrates through and outputs a corresponding current value, which can manifest the transmittance of light beam (22a). Again referring to the concentration-transmittance-temperature relationship graph in FIG. 5, it is obtained by the concentration detector (2) under specific temperature and corresponding to specific fluid concentrations. The aforesaid concentration-transmittance-temperature relationship can be illustrated by a reference table or a functional equation and embedded in the computing device (3) for determining the concentration of fluid (12b) based on the transmittance and temperature of fluid (12b) fed back by the concentration detector (2) and the temperature sensing unit (4). In the implementation of the reference table, the computing device (3) can obtain other data on concentration-transmittance-temperature through extrapolation or interpolation based on the existing concentration-transmittance-temperature relationship.

Thus when the temperature sensing unit (4) outputs an electrical signal corresponding to the temperature detected, and the light sensor (21a) outputs an electrical signal of transmittance corresponding to fluid concentration, the computing device (3) would select a fluid concentration corresponding to the temperature and the transmittance to obtain the concentration of fluid (12b) in a part of the fluid communication space (12a) in fluid circulating device (12).

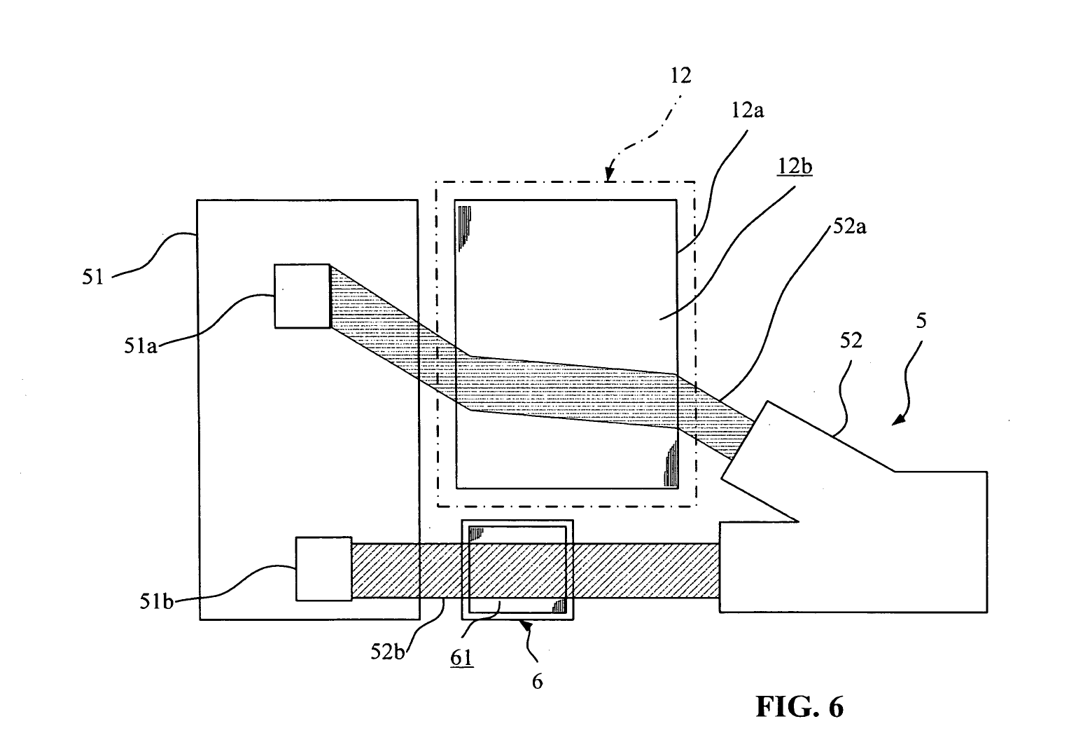

FIG. 6 is a side view of the transmission fluid concentration detector according to the invention and part of components used in a third embodiment. As shown, the fuel cell system (1) further comprises a concentration detector (5) and a standard fluid tank (6). The concentration detector (5) consists of a light sensing device (51) and a light source device (52). The light sensing device (51) comprises a first light sensor (51a) and a second light sensor (51b). The light source device (52) can produce a first light beam (52a) and a second light beam (52b). The standard fluid tank (6) accommodates a standard fluid (61) having known specific concentration. The standard fluid tank (6) is correspondingly disposed in a part of the fluid communication space (12a) in fluid circulating device (12) such that the temperature of the standard fluid (61) therein corresponds to the fluid (12b) temperature in the fluid communication space (12a). The first light beam (52a) and the second light beam (52b) produced by the light source device (52) respectively correspond to a part of the fluid communication space (12a) in fluid circulating device (12) and the standard fluid tank (6), and respectively penetrates the fluid (12b) in a part of the fluid communication space (12a) and the standard fluid (61) in the standard fluid tank (6). The first light sensor (51a) and the second light sensor (51b) of the light sensing device (51) are arranged in coordination with the penetrated first light beam (52a) and the second light team (52b) such that the penetrated first light beam (52a) and the second light team (52b) are respectively incident on the first light sensor (51a) and the second light sensor (51b).

In the third embodiment of the transmission fluid concentration detector according to the invention, the standard fluid (61) is pure water, high-purity fluid or fluid with known specific concentration. In the case of a direct methanol fuel cell, the high-purity fluid is methanol.

The standard fluid tank (6) is arranged corresponding to a part of the fluid communication space (12a) in fluid circulating device (12). In a preferred embodiment, the fluid communication space (12a) in the fluid circulating device (12) can also be a fluid tank for storing fluid, and the standard fluid tank (6) is arranged as in close contact with the fluid communication space (12a) as possible so that the temperature of fluid (12b) in the fluid communication space (12a) and that of standard fluid (61) in the standard fluid tank (6) can be balanced. Moreover, the computing device (3) in the embodiment in FIG. 1 can pre-establish a concentration-transmittance-temperature relationship and compute the concentration of fluid (12b) in a part of the fluid communication space (12a) in fluid circulating device (12) based on the electrical signals output by the first light sensor (51a) and the second light sensor (51b). Because the concentration of standard fluid (61) in the standard fluid tank (6) is known and the second light sensor (51b) can feedback the transmittance of the second light beam (52b) that penetrates the standard fluid (61), the computing device (3) can compute the temperature of the standard fluid (61) of standard fluid tank (6) based on the concentration-transmittance-temperature relationship. Moreover as the temperature of standard fluid (61) corresponds to the temperature of fluid (12b) in the fluid communication space (12a) and the first light sensor (51a) can feedback the transmittance of the first light beam (52a) that penetrates the fluid (12b), the computing device (3) can further compute to obtain the concentration of fluid (12b) in the fluid communication space (12a) of fluid circulating device (12).

In the third embodiment of the transmission fluid concentration detector, the temperature of fluid (12b) in the fluid communication space (12a) can be obtained based on the transmittance of the standard fluid (61) in standard fluid tank (6) as detected by the second light sensor (51b) of the light sensing device (51). Thus there is no need to install another temperature sensor for measuring the temperature of fluid (12b) in the fluid communication space (12a) in order to calibrate the electrical signal output by the first light sensor (51a) and obtain the corresponding concentration of fluid (12b) in the fluid communication space (12a).

The preferred embodiments of the present invention have been disclosed in the examples. However the examples should not be construed as a limitation on the actual applicable scope of the invention, and as such, all modifications and alterations without departing from the spirits of the invention and appended claims shall remain within the protected scope and claims of the invention.

What is claimed is:

1. A transmission fluid concentration detector used primarily in a fluid circulating device, comprising:
a light source device;
a light-sensing device comprising at least a light sensor for converting optical signal into electrical signal, the electrical signal being output by the light sensor while under the state of illumination corresponding to the intensity of optical signal;
a temperature sensing unit arranged corresponding to the fluid circulating device for detecting the temperature of the fluid circulating device; and
a computing device containing a logic operation means for processing the electrical signal output by the light-sensing device and computing corresponding fluid concentration in the fluid circulating device;
wherein the light sensor of the light sensing device and the light source device are arranged oppositely at two sides of a partial space of the fluid circulating device such that the light beam emitted by the light source device can be projected on the light sensor of light sensing device through the fluid in the fluid circulating device, and the light sensor then outputs an electrical signal corresponding to the fluid concentration to the computing device; the computing device comprising a concentration-transmittance-temperature relationship determination means to compute the fluid concentration in a part of the fluid communication space of the fluid circulating device based on the electrical signal output by the light sensor of light sending device and the electrical signal output by the light sensing unit.

2. The transmission fluid concentration detector according to claim 1, wherein the light sensor outputs a current value, the current value corresponding to the transmittance of light beam produced by the light source device and passing through the fluid in a partial space of the fluid circulating device.

3. The transmission fluid concentration detector according to claim 2, wherein the concentration-transmittance-temperature relationship is embedded in the computing device in the form of a reference table or a functional equation for the computing device to determine the fluid concentration based on the light transmittance and temperature of the fluid fed back by the concentration detector and the temperature sensing unit.

4. The transmission fluid concentration detector according to claim 1, wherein the part of the fluid circulating device corresponding to the light beam emitted by the light source device and another part of the fluid circulating device where the light sensor receives the light beam are light transmittable, while the other parts of the fluid circulating device are non-light transmittable.

5. The transmission fluid concentration detector according to claim 1, wherein the light source output by the light source device is infrared light, visible light or single-wavelength light.

6. The transmission fluid concentration detector according to claim 1, wherein the light sensor is a photosensitive element.

7. A transmission fluid concentration detector used primarily in a fluid circulating device, comprising:
a light source device producing at least a first light beam and a second light beam,
a light-sensing device comprising at least a first light sensor and a second light sensor for converting optical signal into electrical signal, the electrical signal being output by the light sensor while under the state of illumination corresponding to the intensity of optical signal;
a standard fluid tank for accommodating a standard fluid, the standard fluid being a fluid with known specific concentration, the standard fluid tank being correspondingly disposed in a partial space of the fluid circulating device and thereby enabling the standard fluid temperature in the standard fluid tank to correspond to the fluid temperature in the fluid circulating device; and
a computing device containing a logic operation means for processing the electrical signal output by the light-sensing device and computing corresponding fluid concentration in the fluid circulating device;
wherein the first light sensor of the light sensing device and the light source device are arranged oppositely at two sides of a partial space of the fluid circulating device, and the second light sensor of the light sensing device and the light source device are arranged oppositely at two sides of the standard fluid tank such that the first light beam and the second light beam emitted by the light source device are respectively projected on the first light sensor and the second light sensor of light sensing device through the fluid in the fluid circulating device and the standard fluid in the standard fluid tank, the first light sensor and the second light sensor of the light sensing device respectively outputting an electrical signal corresponding to the fluid concentration and the standard fluid to the computing device, and based on which, the computing device determining the corresponding fluid concentration; the computing device comprising a concentration-transmittance-temperature relationship determination means to compute the fluid concentration in a part of the fluid circulating device based on the electrical signal output by the light sensor of light sending device and the electrical signal output by the temperature sensing unit.

8. The transmission fluid concentration detector according to claim 7, wherein the first light sensor and the second light sensor respectively output a current value, the current value corresponding to the transmittance of light beam produced by the light source device and passing through the fluid in a partial space of the fluid circulating device and the standard fluid.

9. The transmission fluid concentration detector according to claim 7, wherein the standard fluid is pure water, high-purity fluid or a fluid with known specific concentration.

10. The transmission fluid concentration detector according to claim 9, wherein the high-purity fluid is high-purity methanol.

11. The transmission fluid concentration detector according to claim 7, wherein the light sensor outputs a current value, the current value corresponding to the transmittance of light beam produced by the light source device and passing through the fluid in a partial space of the fluid circulating device.

12. The transmission fluid concentration detector according to claim 11, wherein the concentration-transmittance-temperature relationship is embedded in the computing device in the form of a reference table or a functional equation for the computing device to determine the fluid concentration based on the light transmittance and temperature of the fluid fed back by the concentration detector and the temperature sensing unit.

13. The transmission fluid concentration detector according to claim 7, wherein the part of the fluid circulating device corresponding to the light beam emitted by the light source device and another part of the fluid circulating device where the light sensor receives the light beam are light transmittable, while the other parts of the fluid circulating device are non-light transmittable.

14. The transmission fluid concentration detector according to claim 7, wherein the light source output by the light source device is infrared light, visible light or single-wavelength light.

15. The transmission fluid concentration detector according to claim 7, wherein the light sensors are respectively a photosensitive element.
